(19) United States
(12) Patent Application Publication
(10) Pub. No.: US 2018/0358664 A1
(43) Pub. Date: Dec. 13, 2018

(54) RECHARGEABLE BATTERY PACK WITH ACTIVE OR PASSIVE COOLING

(71) Applicant: MTD PRODUCTS INC, Valley City, OH (US)

(72) Inventors: Quan ZHANG, Mesa, AZ (US); Matthew M. BOSWAY, Gilbert, AZ (US); Lincoln JORE, Scottsdale, AZ (US)

(21) Appl. No.: 15/904,821

(22) Filed: Feb. 26, 2018

Related U.S. Application Data
(60) Provisional application No. 62/516,791, filed on Jun. 8, 2017.

(51) Int. Cl. H01M 10/613; H01M 10/42; H01M 10/643; H01M 2/10; H01M 10/6557

(52) U.S. Cl. CPC H01M 10/613; H01M 10/4207; H01M 2/204; H01M 2/1077; H01M 10/6557; H01M 10/643

(57) ABSTRACT

A rechargeable battery pack having a housing, a plurality of cells located within the housing, a heat sink for dissipating heat from the plurality of cells, wherein the plurality of cells are encapsulated by the heat sink, and at least one elongated cooling channel to provide for active cooling, wherein the elongated cooling channel is within the housing and at least partially defined by the heat sink. A rechargeable battery pack having a housing, a plurality of cells located within the housing, wherein no single cell is completely surrounded by adjacent cells, a heat sink for dissipating heat from the plurality of cells, wherein the plurality of cells are encapsulated by the heat sink, and at least one elongated cooling channel to provide for active cooling, wherein the elongated cooling channel is located within the housing and is at least partially defined by the heat sink.

### CROSS-REFERENCE TO RELATED APPLICATIONS

This application claims priority to U.S. Provisional Patent Application Ser. No. 62/516,791 filed Jun. 8, 2017, and entitled RECHARGEABLE BATTERY PACK WITH ACTIVE OR PASSIVE COOLING, which is herein incorporated by reference in its entirety.

### FIELD OF THE INVENTION

The present invention is generally directed to a rechargeable battery pack, and more particularly, to a sealed rechargeable battery pack with a cooling channel for active or passive cooling.

### BACKGROUND OF THE INVENTION

Rechargeable batteries are extensively used in factory, farm, lawn, and/or household applications. These applications, including tools and instruments, use a plurality of battery cells, where the plurality of battery cells are generally encapsulated into a battery pack, and the battery pack is further coupled and/or mounted to the tools and instruments. Due to the existence of internal resistance, heat will be generated when the battery is charged or discharged. It is difficult to dissipate such heat because these rechargeable batteries are completely encapsulated within a housing and/or the battery group. When battery cells are assembled in a battery group, there are certain cells that will inevitably become completely surrounded on all sides by partnering cells. Because of this, these cells become the hottest part of the battery group and will be the first cells to start degrading. Such degradation limits the performance of the battery from a life cycle standpoint, in addition to affecting the efficiency and service life of the battery group and/or battery pack.

### BRIEF SUMMARY OF THE INVENTION

Generally described hereinafter is a rechargeable battery pack having a housing, a plurality of cells located within the housing, a heat sink for dissipating heat, and at least one elongated cooling channel within the housing and is at least partially defined by the heat sink. The rechargeable battery pack of the present invention provides a plurality of cells that are sealed within the housing, and yet still provides for active and passive cooling.

In one aspect of the invention, the rechargeable battery pack provides a plurality of cells that are immediately adjacent to the heat sink. In some embodiments, at least a portion of the heat sink is exposed to the ambient environment. In some embodiments, the heat sink is located internally within the housing. In some embodiments, the heat sink further comprises a plurality of ribs. In some embodiments, the plurality of ribs are located on the portion of the heat sink that is at least partially exposed to the ambient environment.

According to one aspect of the present invention, the elongated cooling channel is centrally located within the housing and is completely defined by the heat sink. In some embodiments, the elongated cooling channel further includes a cooling medium. In some embodiments, the cooling medium is selected from the group consisting of air, water, or coolant.

In another embodiment, the rechargeable battery pack includes a thermally conductive material that is disposed between the heat sink and each of the plurality of cells.

In yet another aspect of the present invention, the rechargeable battery pack provides a housing, a plurality of cells located within the housing, wherein no single cell is completely surrounded by adjacent cells, a heat sink for dissipating heat from the plurality of cells, wherein the plurality of cells are encapsulated by the heat sink, and at least one elongated cooling channel provides for active or passive cooling, the elongated cooling channel being within the housing and at least partially defined by the heat sink.

In some embodiments, the plurality of cells are immediately adjacent to the heat sink. In some embodiments, the plurality of cells are selected from the group consisting of cylindrical cells, prismatic cells, rectangular cells, or pouch cells. In some embodiments, the plurality of cells include multiple individual cells arranged in offset rows of cells, each row being positioned relative to another. In other embodiments, the plurality of cells are arranged in separate groups of cells. In some embodiments, the plurality of cells are sealed within the housing.

In other embodiments, the elongated cooling channel is centrally located within the housing and is completely defined by the heat sink. In some embodiments, the one elongated cooling channel further includes a cooling medium.

According to yet another aspect of the present invention, the rechargeable battery pack provides a housing, a first and a second heat sink, a first battery group, wherein the first battery group comprises a plurality of cells and is encapsulated by the first heat sink, a second battery group, wherein the second battery group comprises a plurality of cells and is encapsulated by the second heat sink, a thermally conductive material to provide for intermediate heat transfer from the plurality of cells to the first and second heat sinks, and at least one elongated cooling channel for active or passive cooling, the elongated cooling channel being located within the housing and at least partially defined by the first and second heat sinks.

Advantages of the present invention will become more apparent to those skilled in the art from the following description of the embodiments of the invention which have been shown and described by way of illustration. As will be realized, the invention is capable of other and different embodiments, and its details are capable of modification in various respects.

### BRIEF DESCRIPTION OF SEVERAL VIEWS OF THE DRAWINGS

These and other features of the present invention, and their advantages, are illustrated specifically in embodiments of the invention now to be described, by way of example, with reference to the accompanying diagrammatic drawings, in which:

FIG. 1 is a partial side view illustrating one embodiment of the rechargeable battery pack of the present invention;

FIG. 2 is a side view of the sealed case of one embodiment of the rechargeable battery pack shown in FIG. 1;

FIG. 3 is an exploded view illustrating one embodiment of the rechargeable battery pack of the present invention; and

FIG. 4 is a partial top view of one embodiment of the rechargeable battery pack as shown in FIG. 3.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION OF THE PREFERRED EMBODIMENT

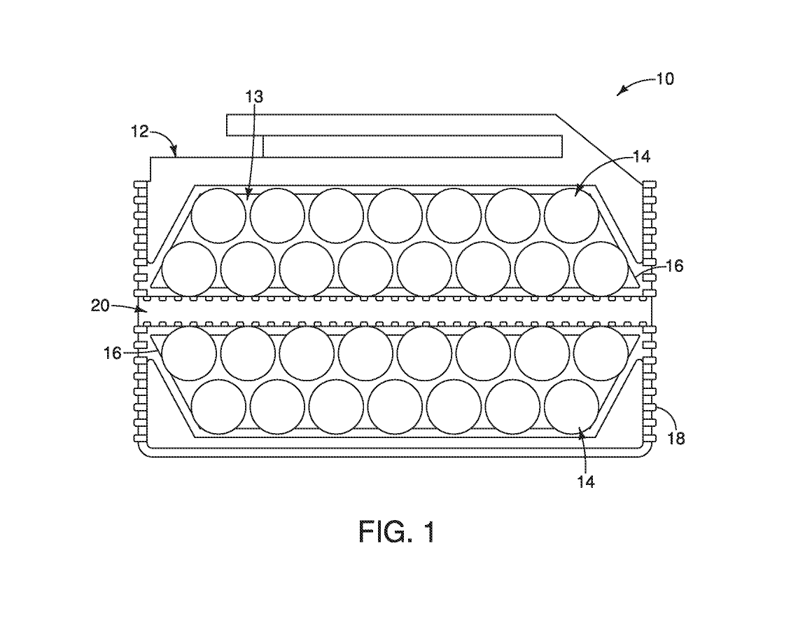

Referring to FIG. 1, an exemplary embodiment of the rechargeable battery pack 10 is shown. In the illustrated embodiment, the rechargeable battery pack 10 includes a housing 12, a plurality of cells 14, a heat sink 16, and an elongated cooling channel 20 for active or passive cooling. It should be understood by one of ordinary skill in the art that the rechargeable battery pack 10 additionally includes electrical connectors or contacts (not shown in figures) that are used to electrically connect the cells 14 contained within the housing 12 to each other and to an outside application.

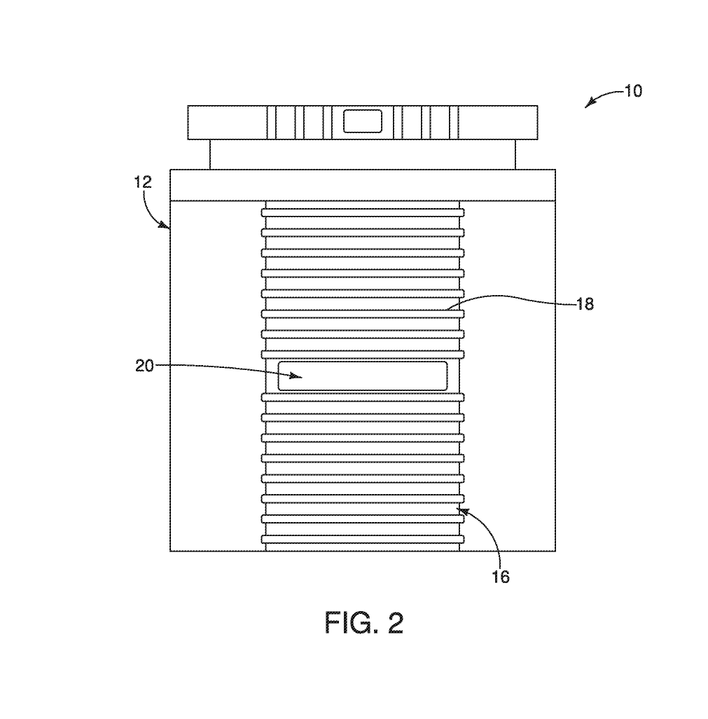

The housing 12 generally defines the sealed rechargeable battery pack 10 and is configured to hold the plurality of cells 14 and the heat sink 16, as shown in FIGS. 1-2. In one embodiment, the housing 12 may be formed of a variety of materials including metal, plastic, coated plastic, composite or other impermeable material.

The housing 12 forms a casing in which the plurality of cells 14 are disposed. The housing 12 also encapsulates the cells 14 in a sealed shell. Each of the cells 14 is made up of individual rechargeable batteries or power cells. Each of the individual batteries or power cells includes a defined amount of power that, when the cumulative amount from each power cell is combined, provides the total output of the battery pack.

In some embodiments, the individual batteries or power cells include, but are not limited to, cylindrical-type batteries. In other embodiments, the cells 14 may be rectangular, square, oval, triangular, or disc-shaped. In some embodiments, the cells 14 can be arranged in two separate groups. In some embodiments, each group of cells 14 include two offset rows of cells, wherein each row of cells 14 are positioned relative to another so that no single cell is completely surrounded by adjacent cells. In some embodiments, there are multiple cells 14 arranged within a group. In some embodiments, there are less than fifteen cells arranged within a group. In other embodiments, there are at least fifteen cells arranged in within a group (as shown in FIG. 1).

As shown in FIGS. 1-2, the rechargeable battery pack 10 also contains a heat sink 16 fixed within the housing 12. The cells 14 are fully encapsulated by the heat sink 16, which dissipates heat away from the cells 14. Unlike traditional battery packs, the cells 14 are arranged so that there is no single cell that is completely surrounded by adjacent cells. Additionally, the cells 14 are configured such that each individual battery or cell is directly adjacent to the heat sink 16. In some embodiments, the cells 14 are in direct contact with the heat sink 16. As the cells 14 are charged and/or discharged, the cells 14 internally generate a large amount of heat. As such, the heat sink 16 provides for the ability to easily dissipate the heat generated due to the configuration or arrangement of the cells 14 relative to the heat sink 16, while still maintaining a sealed shell or casing.

As shown in FIGS. 1-2, by encapsulating the plurality of cells 14 with the heat sink 16, the heat produced by each cell has a direct path to transfer to the heat sink 16. Additionally, the heat sink 16 is at least partially exposed to the ambient environment, wherein the heat sink 16 efficiently dissipates heat by transferring heat generated by the individual cells to the ambient environment. In some embodiments, the heat sink 16 can extend along the entire external surface of the housing 12. In other embodiments, the heat sink 16 is located internally within the battery casing or shell.

In some embodiments, the heat sink 16 is made of aluminum, magnesium, or any thermally conductive material. In some embodiments, the heat sink 16 comprises multiple materials used as the heat sink material. It should be understood by one having ordinary skill in the art that the heat sink 16 is formed of a material possessing good heat transfer properties in order to quickly and effectively transfer the heat generated by the cells to a location remote to these cells in a consistent manner.

As shown in FIG. 1, the battery pack 10 includes a single heat sink 16. In some embodiments, the heat sink 16 is formed by mating together two halves around the cells 14 to form a single heat sink. One having ordinary skill in the art would understand that the heat sink 16 could be comprised of two separate heat sinks 16.

In some embodiments, the heat sink 16 includes a plurality of ribs 18 to provide additional surface area to dissipate heat. The heat sink 16 can include ribs 18 of various sizes, shapes and quantities. The ribs 18 can be placed at different locations on the heat sink 16, either internally or externally. In some embodiments, the ribs 18 are located on the portion of the heat sink 16 that is at least partially exposed to the ambient environment.

As shown in FIG. 1, the rechargeable battery pack 10 also includes a thermally conductive material 13. In some embodiments, as seen in FIG. 1, the thermally conductive material 13 is enclosed within the heat sink 16 and surrounds the cells 14. The thermally conductive material 13 provides for the intermediate heat transfer from the individual cells 14 to the heat sink 16. In some embodiments, the thermally conductive material 13 is located in the gap between the cells 14 and the heat sink 16 to prevent any damage to the individual batteries or cells. In other embodiments, where the cells 14 are in direct contact with the heat sink 16, the thermally conductive material 13 is located only between the cells 14.

In some embodiments, the thermally conductive material 13 comprises of a thermal pad, thermal epoxy, or molded thermally conductive material. It should be understood by one having ordinary skill in the art that the thermally conductive material 13 is formed of a material possessing good heat transfer properties in order to quickly and effectively transfer the heat generated by the cells to the heat sink 16 in a consistent manner.

Now referring to FIGS. 1 and 2, the present invention further includes an elongate cooling channel 20 to provide for active cooling. Active cooling may be defined as either active or passive. Active cooling can be defined as the manner of cooling the cells by positively assisting the heat transfer from the heat sink 16 to the ambient environment through movement of a cooling medium along the surface of the heat sink 16 or heat sink including ribs 18. In some embodiments, the cooling medium includes air, water, coolant or the like. Passive cooling includes the ability of air to flow through the elongate cooling channel 20 from the ambient environment. It should be understood by one skilled in the art that active cooling means actively being cooled, whether by active or passive means.

Active cooling occurs whether the battery pack 10 is in use or non-use, stationary or moving, or whether charging is taking place. In some embodiments, active cooling includes air flowing through the battery pack 10 for cooling during charging and discharging. In some embodiments, active cooling can be defined as the manner of cooling the cells by positively assisting the heat transfer from the heat sink 16 to the ambient environment through movement of air along the surface of the heat sink 16 or ribs 18, wherein the air movement results from movement of the battery during use, which forces ambient air through the cooling channel or by way of the chimney effect within the cooling channel, yet still maintaining a sealed battery pack or sealed environment. In some embodiments, active cooling arises when the battery pack 10 is moved during use. In other embodiments, active cooling occurs due to the heat transfer as air flows from a relatively hot environment to a relatively cooler environment.

The battery pack 10 allows for the individual cells 14 to be exposed to the heat sink 16, which is then exposed to active cooling through the elongated cooling channel 20 for additional heat removal. As such, heat is drawn by the heat sink 16 away from the individual cells towards the elongated cooling channel 20 to dissipate heat. Thus, the rechargeable battery pack 10 allows for uniform temperature distribution by the heat sink 16 in addition to or combination with the active cooling provided by the elongated cooling channel 20.

In some embodiments, the elongated cooling channel 20 is located within the housing 12 and is at least partially defined by the heat sink 16. In other embodiments, as shown in FIGS. 1-2, the elongated cooling channel 20 is centrally located within the housing 12 and is at least partially defined by the heat sink 16. In other embodiments, such as in FIG. 2, the elongated cooling channel 20 is completely defined by the heat sink 16. In some embodiments, the elongated cooling channel 20 is located along the perimeter or periphery of the housing 12.

In some embodiments, the battery pack 10 includes a plurality of elongated cooling channels 20. In some embodiments, the battery pack 10 includes at least two elongated cooling channels 20. In some embodiments, the elongated cooling channel 20 can be branched or linear.

In some embodiments, as shown by FIG. 2, the elongated cooling channel 20 has a rectangular cross-section. In other embodiments, the cross-sectional shape of the elongated cooling channel 20 can be round, square, hexagonal, oval or any other shape that provides a gap that extends along the length of the battery pack. However, the elongated cooling channel 20 of the present invention is not limited thereto and can have various shapes.

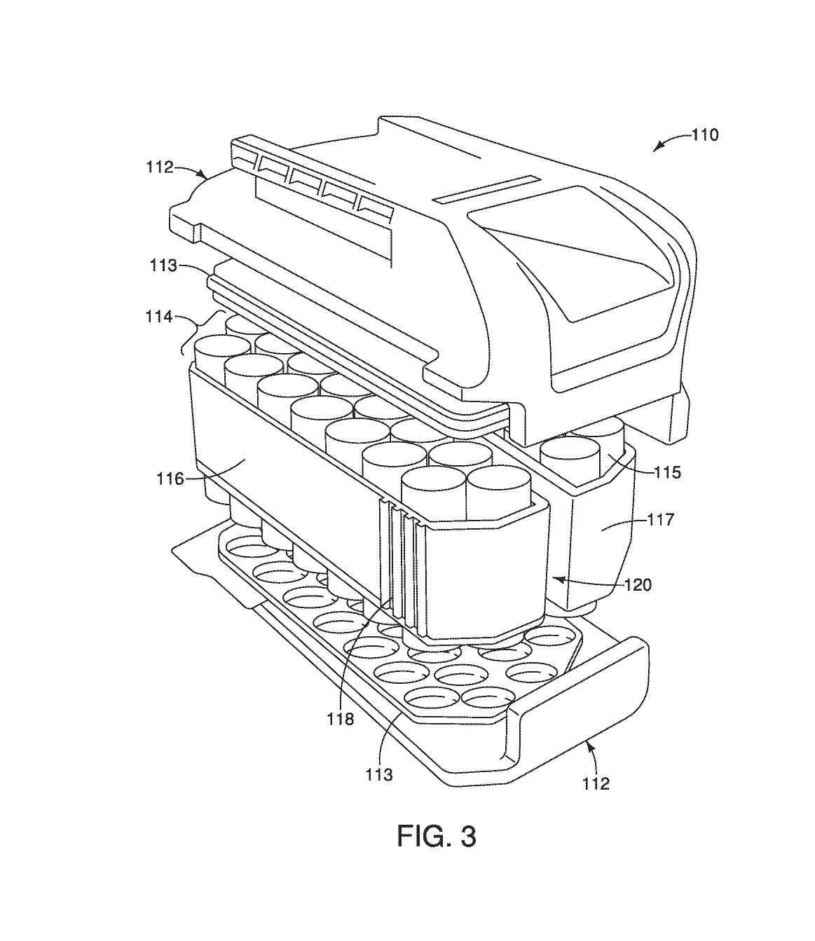

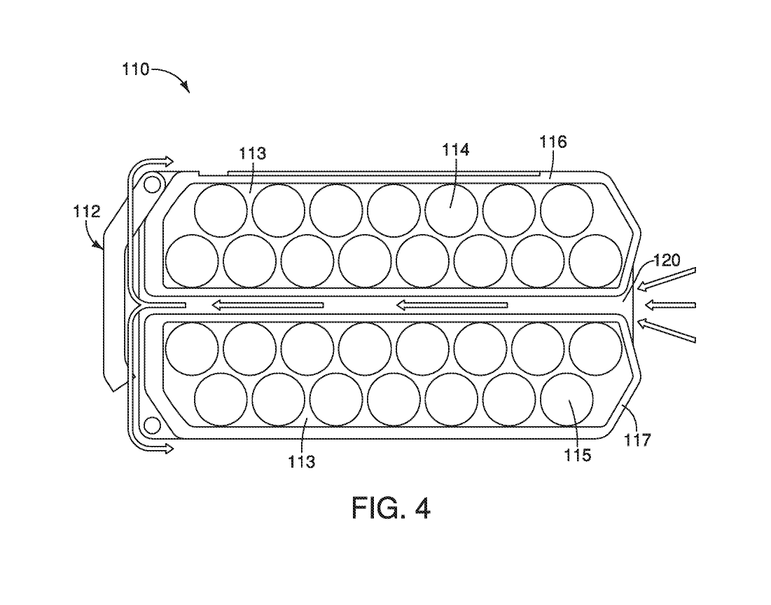

In yet another embodiment, as shown in FIGS. 3 and 4, like parts have like numerals to those in FIGS. 1 and 2, plus 100. In FIGS. 3 and 4, an exemplary embodiment of the rechargeable battery pack 110 is shown. The battery pack 110 includes a housing 112, a first heat sink 116 and a second heat sink 117, a first battery group 114 and a second battery group 115, a thermally conductive material 113, and at least one elongate cooling channel 120 for active cooling.

The housing 112 generally defines the sealed rechargeable battery pack 110 and the first battery group 114, the second battery group 115, where the first heat sink 116 and the second heat sink 117 are disposed therein, as shown in FIG. 3. In one embodiment, the housing 112 may be formed of a variety of materials including metal, plastic, coated plastic, composite or other impermeable material.

The rechargeable battery pack 110 includes a first battery group 114 and a second battery group 115. Both the first battery group 114 and the second battery group 115 are made up of individual batteries or power cells. The first battery group 114 and the second battery group 115 include individual batteries or power cells, which include but are not limited to, cylindrical-type batteries. In other embodiments, the power cells may be rectangular, square, oval, triangular, or disc-shaped.

The rechargeable battery pack 110 also contains a first heat sink 116 and a second heat sink 117. Both first heat sink 116 and second heat sink 117 are fixed within the housing 112, and act to disperse heat away from both battery groups. The first battery group 114 is fully encapsulated by the first heat sink 116, and the second battery group 115 is fully encapsulated by the second heat sink 117.

As shown in FIGS. 3-4, the first heat sink 116 and second heat sink 117 is at least partially exposed to the ambient environment, wherein the heat sinks efficiently dissipate heat by transferring heat generated by the individual cells to the ambient environment. In some embodiments, both first heat sink 116 and second heat sink 117 are exposed to the ambient environment. In other embodiments, either the first heat sink 116 or the second heat sink 117 is exposed to the ambient environment. In some embodiments, either the first heat sink 116 or the second heat sink 117 is located internally within the battery casing or shell, and in other embodiments, either the first heat sink 116 or the second heat sink 117 can be partially located within the battery casing or shell.

Now referring to FIGS. 3-4, the first battery group 114 and the second battery group 115 are encapsulated by the first heat sink 116 and second heat sink 117, respectively. By encapsulating the first battery group 114 with the first heat sink 116 and the second battery group 115 with the second heat sink 117, the heat produced by each individual power cell has a direct path to be transferred through the heat sinks.

In some embodiments, the first heat sink 116 is made of aluminum, magnesium, or a thermally conductive material. In other embodiments, the second heat sink 117 is made of aluminum, magnesium, or a thermally conductive material. In some embodiments, either heat sink comprises multiple materials to be used as the heat sink material. In some embodiments, the first heat sink 116 and the second heat sink 117 are made of the same material. In other embodiments, the first heat sink 116 and the second heat sink 117 are made of different materials. However, it should be understood by one having ordinary skill in the art that either heat sink is formed of a material possessing good heat transfer properties in order to quickly and effectively transfer the heat generated by the cells to a location remote to these cells in a consistent manner.

In some embodiments, the first heat sink 116 includes a plurality of ribs 118, as in FIG. 3. In some embodiments, the second heat sink 117 includes a plurality of ribs. In other embodiments, either the first heat sink 116 or the second heat sink 117, or both, include a plurality of ribs 118.

In a further embodiments, the rechargeable battery pack 110 further provides for an elongated cooling channel 120, as shown in FIGS. 3 and 4. The elongated cooling channel 120 provides for active cooling. Active cooling may be defined as either active or passive. In some embodiments, active cooling includes the manner of cooling the cells by positively assisting the heat transfer from the first heat sink 116 and the second heat sink 117 to the ambient environment through movement of a cooling medium along the surface of both heat sinks. In some embodiments, the cooling medium includes air, water, coolant or the like.

In some embodiments, the elongated cooling channel 120 is located within the housing 112 and is at least partially defined by the heat sinks. In other embodiments, as shown in FIGS. 3-4, the elongated cooling channel 120 is centrally located within the housing 112 and is at least partially defined by the first heat sink 116 and the second heat sink 117. In other embodiments, the elongated cooling channel 120 is located along the perimeter or periphery of the housing 112.

In some embodiments, the elongated cooling channel 120 is linear or branched. As shown in FIG. 4, in some embodiments, the elongated cooling channel 120 extends and curves around the first heat sink 116 and the second heat sink 117, wherein airflow is provided in the direction according to the arrows.

In other embodiments, a plurality of ribs 118 are disposed along the elongated cooling channel 120 to provide additional surface area to further dissipate heat. The plurality of ribs 118 may include various sizes, shapes and quantities. In some embodiments, either the first heat sink 116 or the second heat sink 117 includes a plurality of ribs 118. In other embodiments, both first heat sink 116 and second heat sink 117 include a plurality of ribs 118.

As shown in FIGS. 3 and 4, the rechargeable battery pack 110 also includes thermally conductive material 113. The thermally conductive material 113 is enclosed within the first heat sink 116 and surrounds the first battery group 114. The thermally conductive material 113 is also enclosed within the second heat sink 117 and surrounds the second battery group 115. The thermally conductive material 113 provides for additional heat transfer from the individual cells to the heat sinks. In some embodiments, the thermally conductive material 113 is located in the gap between the battery groups and either heat sink material, thus preventing any damage to the individual batteries or cells. In some embodiments, the thermally conductive material 113 comprises of a thermal pad, thermal epoxy, or molded thermally conductive material. While preferred embodiments of the present invention have been described, it should be understood that the present invention is not so limited and modifications may be made without departing from the present invention. The scope of the present invention is defined by the appended claims, and all devices, processes, and methods that come within the meaning of the claims, either literally or by equivalence, are intended to be embraced therein.

What is claimed is:

1. A rechargeable battery pack comprising:
a housing;
a plurality of cells located within said housing;
a heat sink for dissipating heat from said plurality of cells, wherein said plurality of cells are encapsulated by said heat sink; and
at least one elongated cooling channel to provide for active cooling, said elongated cooling channel within said housing and at least partially defined by said heat sink.

2. The rechargeable battery pack as in claim 1, wherein each of said plurality of cells is immediately adjacent to said heat sink.

3. The rechargeable battery pack as in claim 1, wherein at least a portion of said heat sink is exposed to the ambient environment.

4. The rechargeable battery pack as in claim 1, wherein said heat sink is located internally within said housing.

5. The rechargeable battery pack as in claim 1, wherein said heat sink further comprises a plurality of ribs.

6. The rechargeable battery pack as in claim 5, wherein said plurality of ribs are located on the portion of said heat sink that is at least partially exposed to the ambient environment.

7. The rechargeable battery pack as in claim 1, wherein said at least one elongated cooling channel is centrally located within said housing and is completely defined by said heat sink.

8. The rechargeable battery pack as in claim 1, further including a cooling medium to flow through said at least one elongated cooling channel.

9. The rechargeable battery pack as in claim 8, wherein said cooling medium is selected from the group consisting of air, water, or coolant.

10. The rechargeable battery pack as in claim 1, wherein a thermally conductive material is disposed between said heat sink and said each of said plurality of cells.

11. The rechargeable battery pack as in claim 1, wherein said plurality of cells are sealed within said housing.

12. A rechargeable battery pack comprising:
a housing;
a plurality of cells located within said housing, wherein no single cell is completely surrounded by adjacent cells;
a heat sink for dissipating heat from said plurality of cells, wherein said plurality of cells are encapsulated by said heat sink; and
at least one elongated cooling channel to provide for active cooling, said elongated cooling channel within said housing and at least partially defined by said heat sink.

13. The rechargeable battery pack as in claim 12, wherein each of said plurality of cells is immediately adjacent to said heat sink.

14. The rechargeable battery pack as in claim 12, wherein said plurality of cells are selected from the group consisting of cylindrical cells, rectangular, square, oval, triangular, or disc-shaped.

15. The rechargeable battery pack as in claim 12, wherein said plurality of cells include fifteen individual cells arranged in two offset rows of cells, each row being positioned relative to another.

16. The rechargeable battery pack as in claim 12, wherein said plurality of cells are arranged in two separate groups of cells.

17. The rechargeable battery pack as in claim 12, wherein said at least one elongated cooling channel is centrally located within said housing and is completely defined by said heat sink.

18. The rechargeable battery pack as in claim 12, further including a cooling medium to flow through said at least one elongated cooling channel.

19. The rechargeable battery pack as in claim 12, wherein said plurality of cells are sealed within said housing.

20. A rechargeable battery pack comprising:
a housing;
a first and a second heat sink;
a first battery group, said first battery group comprising a plurality of cells, wherein said first battery group is encapsulated by said first heat sink;
a second battery group, said second battery group comprising a plurality of cells, wherein said second battery group is encapsulated by said second heat sink;
a thermally conductive material to provide for intermediate heat transfer from said plurality of cells to said first and second heat sinks; and
at least one elongated cooling channel for active cooling, said elongated cooling channel being located within said housing and at least partially defined by said first and second heat sinks.
